(19) United States
(12) Patent Application Publication
(10) Pub. No.: US 2010/0100349 A1
(43) Pub. Date: Apr. 22, 2010

(54) Method and System for Automatically Generating Do-Not-Inspect Regions of a Photomask

(76) Inventors: Peter Daniel Buck, Aloha, OR (US); Richard Walter Gladhill, Portland, OR (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/644,631

(22) Filed: Dec. 22, 2009

Related U.S. Application Data
(63) Continuation of application No. PCT/US2007/072319, filed on Jun. 28, 2007.

(51) Int. Cl. G06F 19/00

(52) U.S. Cl. 702/81

(57) ABSTRACT

A method and system for inspecting a photomask are provided. A method for automatically generating do-not-inspect regions in a photomask includes performing one or more manufacturing rules checks (MRCs) on a mask pattern file. The method may also include identifying manufacturing rule violations and automatically generating one or more DNIRs, each DNIR corresponding to a location of one or more of the identified manufacturing rule violations.

### RELATED APPLICATION

This application is a Continuation of International Application No. PCT/US2007/072319 filed Jun. 28, 2007, which designates the United States of America, the entire disclosure of which is hereby incorporated by reference.

### TECHNICAL FIELD

This invention relates in general to photolithography and, more particularly, a method and system for generating do-not-inspect regions in a photomask.

### BACKGROUND

As device manufacturers continue to produce smaller and more complicated devices, photomasks used to fabricate these devices continue to require a wider range of capabilities. Photomasks, also known as reticles or masks, typically consist of substrates that have a patterned layer formed on the substrate. The patterned layer typically includes a pattern formed in an absorber material (e.g., chrome and/or other suitable materials) that represents an image that may be transferred onto a wafer in a lithography system.

Defects located on manufactured photomasks are a major source of yield loss in photomask manufacturing. For example, defects may cause errors in the transfer of an image onto a wafer in a photolithographic process. When a defect is discovered on a photomask, the defect must often be repaired or the photomask must be rejected.

Defects are often detected with automated inspection systems that compare geometries formed on a photomask with manufacturing data used to form the photomask. However, when inspecting a photomask with an automated inspection system, certain areas of the photomask may be found containing geometries that are flagged as defects, but the presence of these geometries may not be detrimental to the proper functioning of the photomask.

For example, in certain situations, a defect may be ignored if it is determined that the defect will not adversely affect the proper functioning of the photomask or a photolithographic component (e.g., a wafer or integrated circuit) manufactured using the photomask. These “false defects” may be due to partially resolved patterns or other types of geometries that the inspection system flags as defects, whether or not they may potentially have any detrimental effect upon the proper functioning of the photomask. Often, a determination that these automatically-identified false defects are indeed false defects may involve manually reviewing each automatically-identified real and false defect, which may be a time-consuming and error-prone process. For instance, the presence of numerous occurrences of false defects may blind a reviewer of the inspection results to real defects. In addition, an inspection tool may abort during an inspection because the defect storage capacity of the inspection tool may be exceeded.

One solution to prevent the automatic identification of false defects is to “de-tune” or desensitize an inspection tool to ignore spurious false defects. However, such desensitizing may cause an inspection system to become blind to real defects.

Accordingly, do-not-inspect regions (DNIRs) may be specified such that an automatic inspection module may ignore regions with false defect detections. Alternatively, an automatic inspection module may be instructed to inspect regions designated as DNIRs with less sensitivity so that false defects are ignored, while areas of the mask outside of the designated DNIRs are inspected with more sensitive settings. For example, an inspection with greater sensitivity might be expected to identify a greater number of real defects, but may also identify a greater number of false defects. On the other hand, an inspection with lesser sensitivity may identify a lesser number of false defects, but may also identify a lesser number of real defects. However, if inspecting an area of a photomask expected to have a large number of false defects, it may be beneficial to inspect the area using a lower sensitivity, so as to avoid detection of the false defects.

Using conventional approaches, the process of setting DNIRs manually may be a time consuming process and subject to human error. A human operator setting DNIRs may select the wrong areas or may combine nearby areas into a single, large DNIR when the inspection system is capable of supporting multiple, smaller DNIRs so that more of the photomask is inspected with the more sensitive settings.

Previous techniques for generating regions of a photomask subject to differing inspection criteria include the method described in U.S. Pat. No. 6,966,047. The method described therein relies on access to circuit design data corresponding to a circuit to be manufactured using a photomask set including the photomask in question. Various “flags” are set according to functionality of a circuit. These flags are then used in conjunction with an inspection tool to define different requirements for inspection criteria at the time of inspection.

From a photomask manufacturer's point of view, a problem with this approach is that it typically relies on access to the circuit pattern data in design form. Often, an owner of design data may not want to release circuit pattern data to a photomask manufacturer in design form, fearing loss of proprietary information or other undesirable results. Furthermore, this approach typically requires a specially outfitted inspection tool to make use of the flags derived from the design data.

### SUMMARY OF THE DISCLOSURE

In accordance with teachings of the present disclosure, disadvantages and problems associated with analyzing, identifying and dispositioning defects located on a photomask have been substantially reduced or eliminated. In a particular embodiment, manufacturing rule check violations may be used to identify one or more regions of a photomask that may not be included in an automatic inspection of a photomask.

In accordance with one embodiment of the present disclosure, a method for inspecting a photomask is provided. One or more manufacturing rules checks (MRCs) may be performed on a mask pattern file. Based on the one or more MRCs, manufacturing rule violations may be identified, and one or more do-not-inspect regions (DNIRs) may be generated, each DNIR corresponding to a location of one or more of the identified manufacturing rule violations.

In accordance with another embodiment of the present disclosure, software for inspecting photomask is provided. The software may be embodied in tangible computer readable media. When executed, the software may be operable to: perform one or more manufacturing rules checks (MRCs) on a mask pattern file; identify manufacturing rule violations; and automatically generate one or more do-not-inspect regions, (DNIRs), each DNIR corresponding to a location of one or more of the identified manufacturing rule violations.

In accordance with another embodiment of the present disclosure, a system for inspecting a photomask may include a manufacturing rules check (MRC) module and a do-not-inspect region (DNIR) module. The MRC module may be operable to perform one or more manufacturing rules checks (MRCs) on a mask pattern file, and identify manufacturing rule violations. The DNIR module may be operable to automatically generate one or more DNIRs, each DNIR corresponding to a location of one or more of the identified manufacturing rule violations.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 illustrates a cross-sectional view of a photomask assembly according to teachings of the present disclosure;

FIG. 2 illustrates a photolithography system that images a pattern created by a patterned layer and clear areas on a photomask onto the surface of a photolithographic component, according to teachings of the present disclosure;

FIG. 3 illustrates an example mask layout file depicting layout geometries that may lead to generation of false defects during an inspection of a photomask manufactured using the mask layout file, according to the teachings of the present disclosure;

FIG. 4 illustrates an example system for inspecting a photomask, according to the teachings of the present disclosure;

FIG. 5 illustrates a flow diagram for an example method for inspecting a photomask, according to the teachings of the present disclosure;

FIG. 6 illustrates a flow diagram for an example method for generating do-not-inspect regions (DNIRs), according to the teachings of the present disclosure;

FIG. 7A illustrates a mask layout file containing manufacturing rule violations, in accordance with the teachings of the present disclosure;

FIGS. 7B-7D illustrate enlarged views of the manufacturing rule violations depicted in FIG. 7A; and

FIGS. 7E-7H illustrate various steps of the method of generating DNIRs depicted in FIG. 6, according to the teachings of the present disclosure.

### DETAILED DESCRIPTION

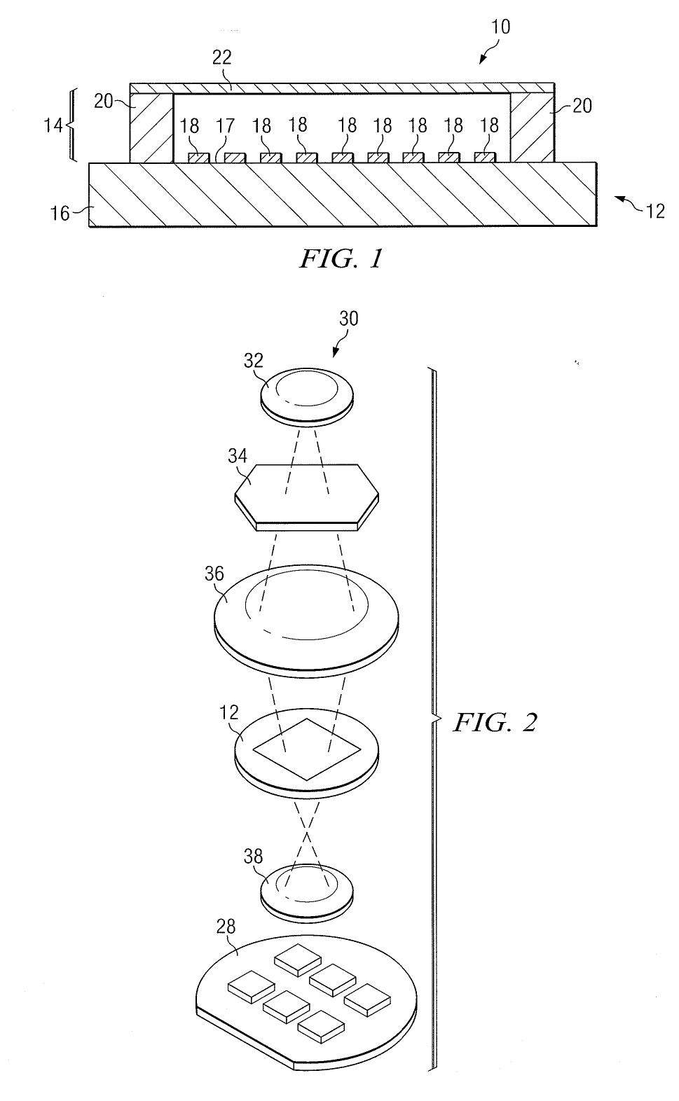

Preferred embodiments of the present disclosure and their advantages are best understood by reference to FIGS. 1 through 7H, where like numbers are used to indicate like and corresponding parts.

FIG. 1 illustrates a cross-sectional view of an example photomask assembly 10. Photomask assembly 10 includes pellicle assembly 14 mounted on photomask 12. Substrate 16 and patterned layer 18 form photomask 12, otherwise known as a mask or reticle, that may have a variety of sizes and shapes, including but not limited to round, rectangular, or square. Photomask 12 may also be any variety of photomask types, including, but not limited to, a one-time master, a five-inch reticle, a six-inch reticle, a nine-inch reticle or any other appropriately sized reticle that may be used to project an image of a circuit pattern onto a semiconductor wafer. Photomask 12 may further be a binary mask, a phase shift mask (PSM) (e.g., an alternating aperture phase shift mask, also known as a Levenson type mask), an optical proximity correction (OPC) mask or any other type of mask suitable for use in a lithography system. In other embodiments, photomask 12 may be a step and flash imprint lithography (SFIL) template used to form an imprint of a pattern in a polymerizable fluid composition that solidifies to form a device on a wafer. The template may be a semi-transparent material, and the polymerizable fluid may be solidified by exposure to a radiation source in order to form the device on the wafer.

Photomask 12 includes patterned layer 18 formed on top surface 17 of substrate 16 that, when exposed to electromagnetic energy in a lithography system, projects a pattern onto a surface of a photolithographic component, e.g. a semiconductor wafer (not expressly shown). In some embodiments, substrate 16 may be a transparent material such as quartz, synthetic quartz, fused silica, magnesium fluoride (MgF₂), calcium fluoride (CaF₂), or any other suitable material that transmits at least seventy-five percent (75%) of incident light having a wavelength between approximately 10 nanometers (nm) and approximately 450 nm. In an alternative embodiment, substrate 16 may be a reflective material such as silicon or any other suitable material that reflects greater than approximately fifty percent (50%) of incident light having a wavelength between approximately 10 nm and approximately 450 nm.

In some embodiments, patterned layer 18 may be a metal material such as chrome, chromium nitride, a metallic oxy-carbo-nitride (e.g., MOₓC_{y}N_{z}, where M is selected from the group consisting of chromium, cobalt, iron, zinc, molybdenum, niobium, tantalum, titanium, tungsten, aluminum, magnesium, and silicon), or any other suitable material that absorbs electromagnetic energy with wavelengths in the ultraviolet (UV) range, deep ultraviolet (DUV) range, vacuum ultraviolet (VUV) range and extreme ultraviolet range (EUV). In an alternative embodiment, patterned layer 18 may be a partially transmissive material, such as molybdenum silicide (MoSi), which has a transmissivity of approximately one percent (1%) to approximately thirty percent (30%) in the UV, DUV, VUV and EUV ranges.

Frame 20 and pellicle film 22 may form pellicle assembly 14. Frame 20 is typically formed of anodized aluminum, although it could alternatively be formed of stainless steel, plastic or other suitable materials that do not degrade or outgas when exposed to electromagnetic energy within a lithography system. Pellicle film 22 may be a thin film membrane formed of a material such as nitrocellulose, cellulose acetate, an amorphous fluoropolymer, such as TEFLON® AF manufactured by E. I. du Pont de Nemours and Company or CYTOP® manufactured by Asahi Glass, or another suitable film that is transparent to wavelengths in the UV, DUV, EUV and/or VUV ranges. Pellicle film 22 may be prepared by a conventional technique such as spin casting, for example.

Pellicle film 22 may protect photomask 12 from contaminants, such as dust particles, by ensuring that the contaminants remain a defined distance away from photomask 12. This may be especially important in a lithography system. During a lithography process, photomask assembly 10 may be exposed to electromagnetic energy produced by a radiant energy source within the lithography system. The electromagnetic energy may include light of various wavelengths, such as wavelengths approximately between the I-line and G-line of a Mercury arc lamp, or DUV, VUV or EUV light. In operation, pellicle film 22 may be designed to allow a large percentage of the electromagnetic energy to pass through it. Contaminants collected on pellicle film 22 will likely be out of focus at the surface of the wafer being processed and, therefore, the exposed image on the wafer should be clear. Pellicle film 22 formed in accordance with the teachings of the present disclosure may be satisfactorily used with all types of electromagnetic energy and is not limited to lightwaves as described in this application.

Photomask 12 may be formed from a photomask blank using a standard lithography process. In a lithography process, a mask pattern file that includes data for patterned layer 18 may be generated from a mask layout file. In one embodiment, the mask layout file may include polygons that represent transistors and electrical connections for an integrated circuit. The polygons in the mask layout file may further represent different layers of the integrated circuit when it is fabricated on a semiconductor wafer. For example, a transistor may be formed on a semiconductor wafer with a diffusion layer and a polysilicon layer. The mask layout file, therefore, may include one or more polygons drawn on the diffusion layer and one or more polygons drawn on the polysilicon layer. In the same or alternative embodiments, the mask layout file may include polygons or shapes that represent features to be fabricated in and/or upon magnetic memory devices, micro-electrical mechanical systems (MEMS), biological MEMS (bio-MEMS), and/or optics devices.

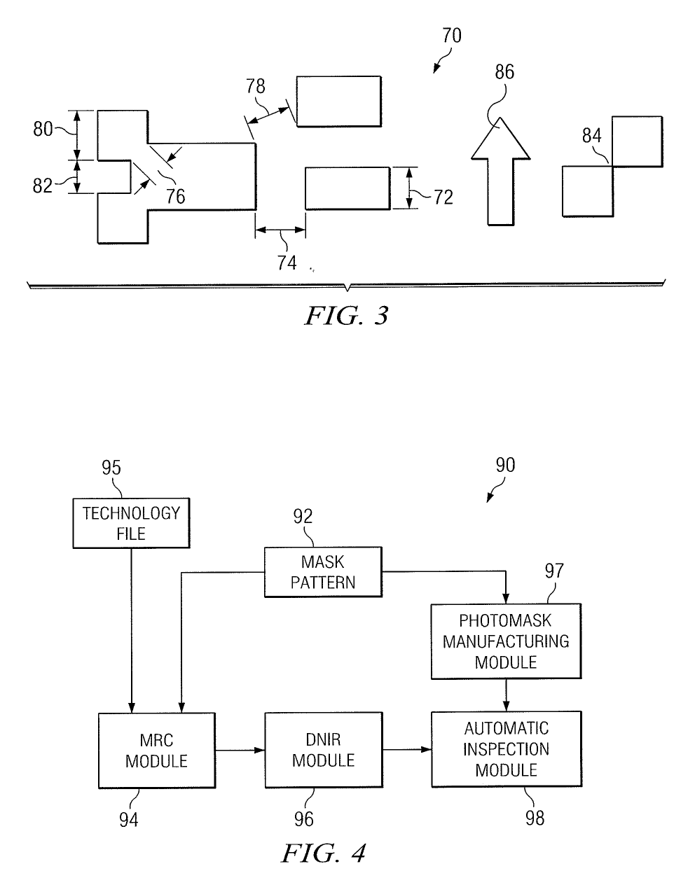

In electrical and/or integrated circuit applications, the polygons for each layer may be converted into a mask pattern file that represents one layer of an integrated circuit. In such an application, each mask pattern file may be used to generate a photomask for the specific layer. In some embodiments, the mask pattern file may include more than one layer of an integrated circuit such that a photomask may be used to image features from more than one layer onto the surface of a semiconductor wafer, as set forth in greater detail in FIG. 2. In the same or alternative embodiments, the polygons for each layer may represent a feature to be fabricated in and/or upon magnetic memory devices, micro-electrical mechanical systems (MEMS), biological MEMS (bio-MEMS), and/or optics devices.

In certain embodiments, one or more polygons in a mask pattern file may not represent actual electrical, mechanical or optical components, but may be present only to assist in the lithographic process. For example, one or more polygons may comprise sub-resolution assist features (SRAFs), also known as “scattering bars,” “serifs” and/or simply “assist features,” take advantage of the fact that edges of near- and sub-wavelength features located in dense areas of a photomask are typically resolved more sharply in a photolithographic system, as compared to isolated features. Accordingly, an SRAF is a feature that may be printed on a photomask near an existing feature to improve the imaged resolution of the existing feature as if the existing feature were in a densely packed area. The SRAFs, however, may be so narrow that they do not appear on a substrate imaged by the photomask—hence the name “sub-resolution.”

The desired pattern may be imaged into a resist layer of the photomask blank using a laser, electron beam or X-ray lithography system, for example. In one embodiment, a laser lithography system uses an argon-ion laser that emits light having a wavelength of approximately 364 nanometers (nm). In alternative embodiments, the laser lithography system may use lasers emitting light at wavelengths from approximately 150 nm to approximately 450 nm. In other embodiments, a 25 key or 50 keV electron beam lithography system uses a lanthanum hexaboride or thermal field emission source. In the same or alternative embodiments, an electron beam lithography system uses a vector-shaped electronic beam lithography tool. In further embodiments, different electron beam lithography systems may be used. Photomask 12 may be fabricated by developing and etching exposed areas of the resist layer to create a pattern, etching the portions of patterned layer 18 not covered by resist, and removing the undeveloped resist to create patterned layer 18 over substrate 16.

FIG. 2 illustrates a photolithography system 30 that images a pattern created by patterned layer 18 on photomask 12 onto the surface of photolithographic component 28. Photolithography system 30 may include light source 32, filter 34, condenser lens 36 and reduction lens 38. In one embodiment, light source 32 may be a mercury vapor lamp that emits wavelengths between approximately 350 nm and 450 nm. In another embodiment, light source 32 may be an argon-ion laser that emits a wavelength of approximately 364 nm. In other embodiments, light source 32 may emit wavelengths between approximately 150 nm and approximately 350 nm. Filter 34 may select the wavelength to be used in photolithography system 30 and condenser lens 36 and reduction lens 38 may use refractive optics to focus the radiant energy from light source 32 respectively onto photomask 12 and photolithographic component 28.

During a photolithography process, electromagnetic energy may illuminate photomask 12 and an image of the pattern on photomask 12 may be projected onto photolithographic component 28. The pattern on photomask 12 may be reduced by reduction lens 38 such that the image is only projected on a portion of photolithographic component 28. Photolithography system 30 may then realign photolithographic component 28 so that the pattern from photomask 12 may be imaged onto another portion of photolithographic component 28. The process may be repeated until all or most of the surface of photolithographic component 28 is covered by multiple instances of the pattern from photomask 12.

In accordance with the present disclosure, photolithographic component 28 may include, without limitation, photomasks, semiconductor wafers (e.g. silicon and gallium arsenide wafers), thin film transistor array substrates (e.g. for use in the manufacture of LCDs, flat panel displays and color filters), glass masters (e.g., for use in the manufacture of compact disks and DVDs), or any other suitable substrate which can be processed using photolithography.

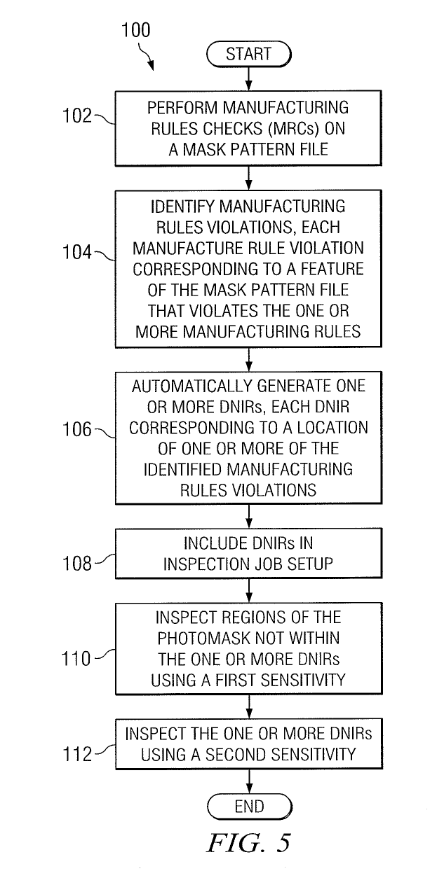

As shown in FIG. 3, false defects may arise from features that are too small and/or too narrow to be resolved by a photomask manufacturing system. For example, small features, such as feature 72, while present in mask pattern file 70, may not subsequently appear on a photomask manufactured using mask pattern file 70 due to resolution limits of a photomask manufacturing system. Consequently, when the manufactured photomask is inspected, an automatic inspection module may determine that feature 72 does not have a corresponding structure on the photomask, thus flagging the missing structure as a defect.

In addition, false defects may arise where spacing between geometries is smaller than the resolution of a photomask manufacturing system, as illustrated by feature 74. In such a case, feature 74 appearing in mask pattern file 70 as a space may be too small to be resolved on a photomask, possibly creating a bridge rather than a space between two structures on a photomask separated by feature 74. Similarly, resolution limits may also cause false defects in geometries in which corners are too close together to be properly resolved in a photomask, as depicted by features 76 and 78, and/or by optical proximity correction features (e.g., SRAFs, discussed above), as depicted by features 80 and 82. In certain cases, resolution limits may cause “rounding” of structures, for example singularities (feature 84) and/or acute angles (feature 86), which may also lead to the detection of false defects.

Geometries that may cause false defects may be identified using manufacturing rules checks (MRCs). Generally speaking, MRCs may comprise a series of analyses, tests, and/or comparisons that compare the contents of one or more mask pattern files to one or more predetermined parameters known as manufacturing rules. Manufacturing rules may be one or more parameters provided by a photomask manufacturer that enable one to determine whether a particular mask pattern file has geometries for which a corresponding structure may not be formed on a photomask manufactured using the particular mask pattern file. For example, the identification of manufacturing rule violations may be used to identify geometries (e.g. features 72-86) that, because of resolution limitations of a photomask manufacturing process, may not produce corresponding structures on a photomask, and thus lead to the detection of false defects by an automatic inspection system and/or render one or more portions of a photomask uninspectable.

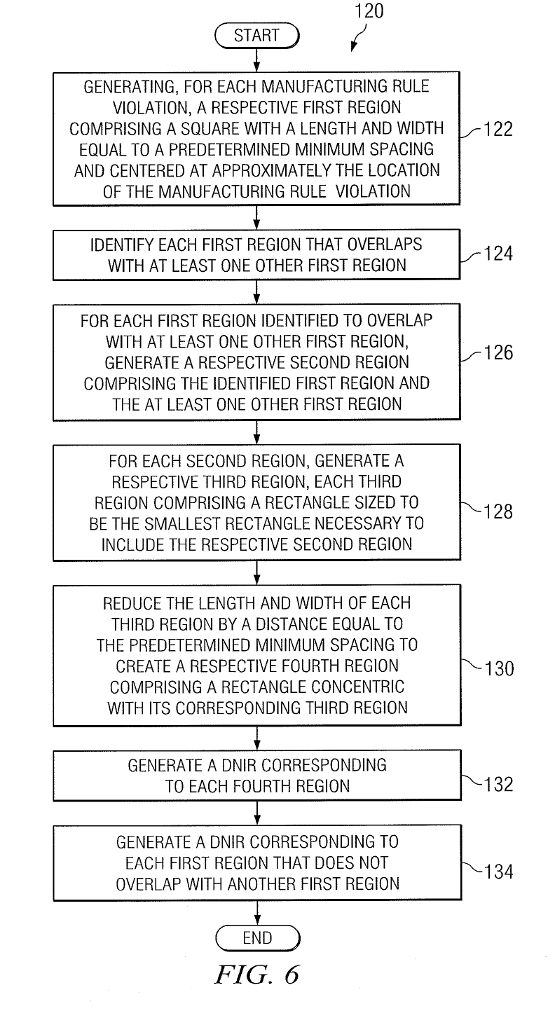

Accordingly, with a suitably constructed suite of manufacturing rules, these geometries can be found in mask pattern files prior to reaching the inspection step of a photomask manufacturing process, and used to generate one or more do-not-inspect regions (DNIRs) of the photomask (as described in greater detail below in reference to FIGS. 4-7H). Thus, by identifying manufacturing rule violations, DNIRs corresponding to the individual manufacturing rule violations may be created, thereby potentially reducing the number of false defects detected by an automatic inspection module.

FIG. 4 illustrates an example system 90 for inspecting a photomask, according to the teachings of the present disclosure. As depicted in FIG. 4, system 90 may include mask pattern file 92, MRC module 94, technology file 95, DNIR module 96, photomask manufacturing module 97, and automatic inspection module 98.

Mask pattern file 92 may be stored and/or embodied in a computer-readable medium. As used in this disclosure, “computer-readable medium” may comprise any suitable system, device or apparatus for storing data, instructions, and/or media readable by a computer, and may include a direct access storage device (e.g. hard disk drive), sequential access storage device (e.g. tape drive), random access memory (RAM), electrically erasable programmable read-only memory (EEPROM), a PCMCIA card, flash memory, or any suitable selection and/or array of volatile or non-volatile memory.

In operation, mask pattern file 92 may include one or more geometric patterns defining the topography of a photomask to be manufactured using mask pattern file 92. As used in this disclosure, the term “topography” means the geometric layout and/or orientation of a patterned layer on a photomask, e.g., patterned layer 18 of photomask assembly 10. Some or all of the data used to write mask pattern file 92 may comprise and/or be constructed from data used by a photomask manufacturer to write and/or inspect the various photomasks in a photomask set. Under this approach, mask pattern file 92 may be constructed using data readily available to a photomask manufacturer, and does not require pattern data in circuit design form or access to other data sources or formats. In the same or alternative embodiments, some or all of the data used to write mask pattern file 92 may comprise and/or be constructed from design data provided by the owner of the design.

MRC module 94 (and/or any other component of system 90) may be operable to perform one or more MRCs on mask pattern file 92. MRC module 94 may also be operable to identify manufacturing rule violations. In certain embodiments, each manufacturing rule violation may correspond to a feature of mask pattern file 92 (e.g. features similar to features 72-86 of mask pattern file 70) that violates one or more manufacturing rules. For example, MRC module 94 may use any suitable MRC tool to compare feature dimensions in mask pattern file 92 to manufacturing rules for a desired manufacturing process. The manufacturing rules may be included in a technology file 95 that is used by MRC module 94 and may represent the minimum allowable feature dimensions (e.g., spaces between features and dimensions of features) for the desired manufacturing process. Technology file 95 may be embodied and/or stored on a computer-readable medium. If the feature dimensions in the mask pattern file 92 are greater than or equal to the minimum allowable sizes, MRC module 94 may generate an output file that indicates that data file 92 does not include any manufacturing rule violations. On the other hand, if at least one feature dimension in the data file is less than a minimum allowable size, the MRC module may generate an output file that contains any identified manufacturing rule violations. The output file may be used by system 90 to locate coordinates of features in the mask pattern file 92 that are associated with the manufacturing rule violations.

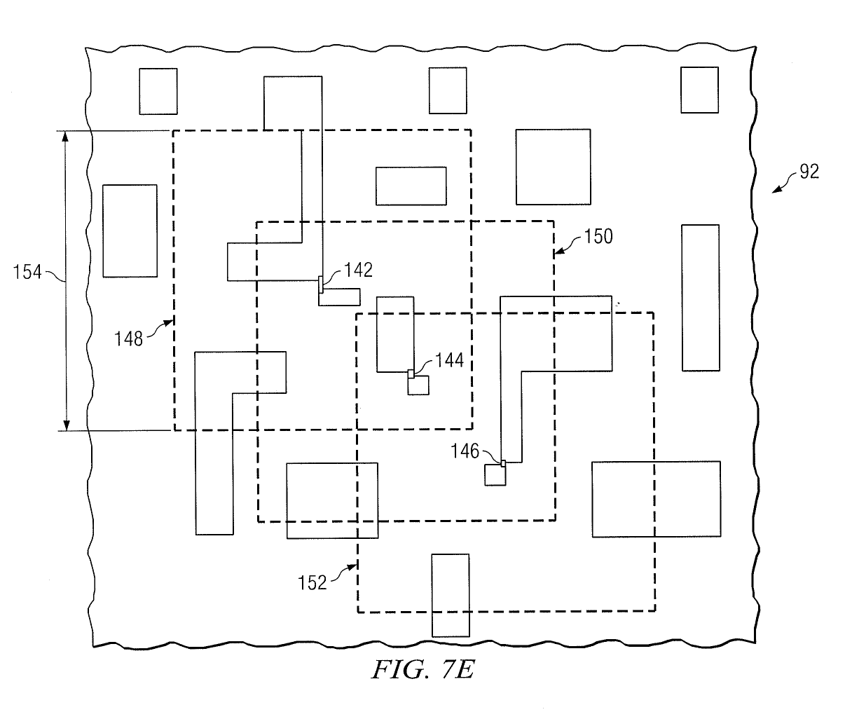

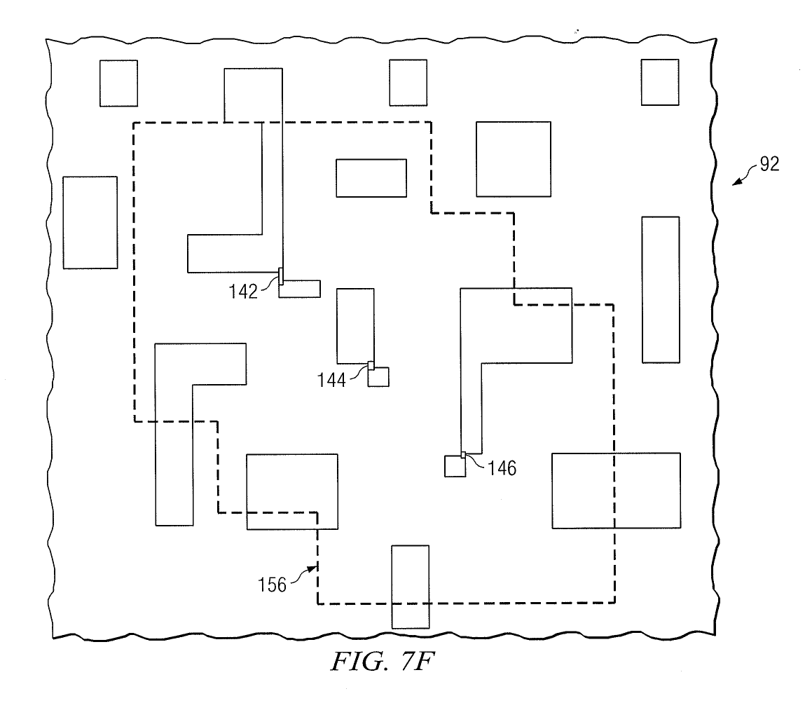

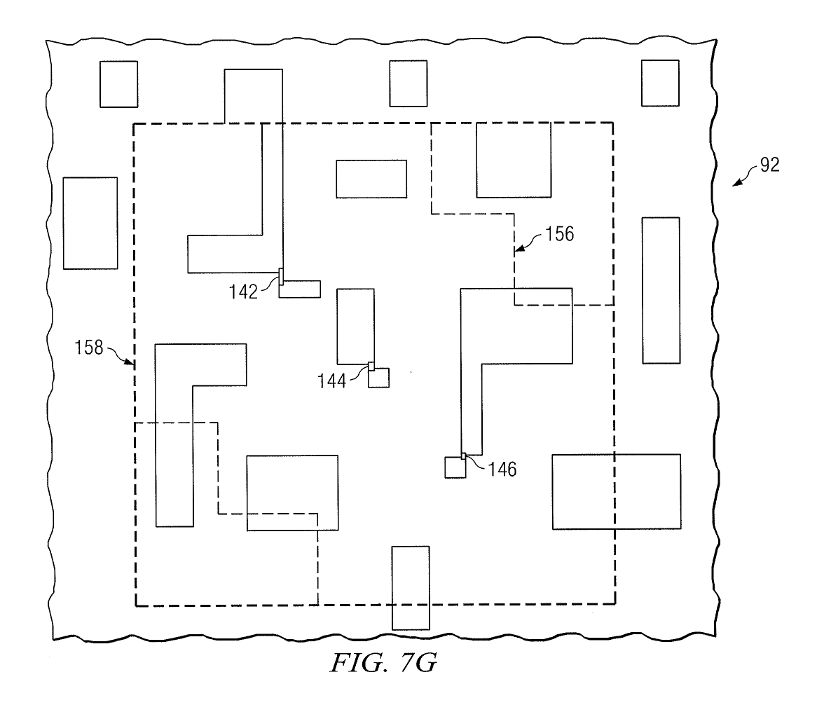

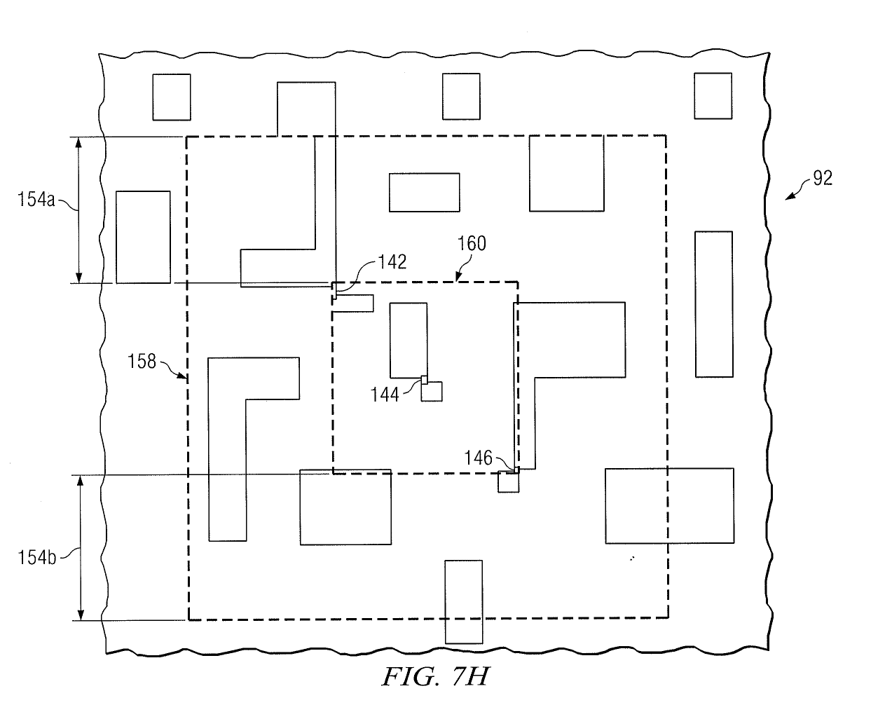

Once mask pattern file 92 is analyzed by MRC module 94, DNIR module 96 (and/or any other component of system 90) may automatically generate DNIRs. In certain embodiments, each DNIR may correspond to a location of one or more of the identified manufacturing rule violations. In the same or alternative embodiments, DNIR module 96 may generate DNIRs in accordance with methods described below with reference to FIGS. 6-7H.

Photomask manufacturing module 97 may be any suitable device, system or apparatus operable to read, parse, and/or otherwise examine mask pattern file 92 to manufacture a photomask with a topology corresponding to the features of mask pattern file 92. Automatic inspection module 98 may generally be operable to inspect defects located on a photomask manufactured using photomask manufacturing module 97 and mask pattern file 92. To detect defects, automatic inspection module 98 may perform an inspection of a photomask using any suitable method or means for inspecting a photomask, e.g., photomask 12. In certain embodiments, automatic inspection module 98 may be operable to inspect only those regions of a photomask not within one or more of the DNIRs generated by DNIR module 96. In other embodiments, automatic inspection module may be operable to inspect only those regions not within the one or more DNIRs using a first sensitivity, and inspect the one or more DNIRs using a second sensitivity. For example, regions of a photomask not within the DNIRs may be inspected with a sensitivity that would be high enough to detect false defects occurring within the DNIRs, while the DNIRs may be inspected with a lower sensitivity low enough to ignore the false defects occurring within the DNIRs. By inspecting DNIRs with a lower sensitivity as compared with the sensitivity used to inspect the remainder of the photomask, generation of false defects may be avoided in areas prone to false defects, while still inspecting areas outside of the DNIRs with a high sensitivity and thus potentially avoiding the possibility of failing to detect real defects that might occur in inspecting an entire photomask with a low sensitivity. In addition, because DNIR module 96 may automatically generate DNIRs, DNIRs need not be created manually by an inspection tool operator, thereby potentially reducing any human error incumbent in identifying DNIRs.

Additionally, automatic inspection module 98 (or another component of system 90) may extract defect data regarding the detected defects (e.g., size, location, and/or type) via electronic means. The defect data may be communicated from automatic inspection module 98 to another component of system 90 and/or another system, device or apparatus for further processing and analysis.

Although the foregoing discussion contemplates that the various modules and components of system 90 possess certain functionality, it is understood that any the functionality discussed with respect to a particular component of system 90 may in fact be undertaken by any other module or component of system 90.

Each of MRC module 94, DNIR module 96, photomask manufacturing module 97, and automatic inspection module 98 may be implemented in hardware, software, or any combination thereof. In certain embodiments, any of MRC module 94, DNIR module 96, photomask manufacturing module 97, and automatic inspection module 98 may comprise a program of instructions embodied in a computer-readable medium.

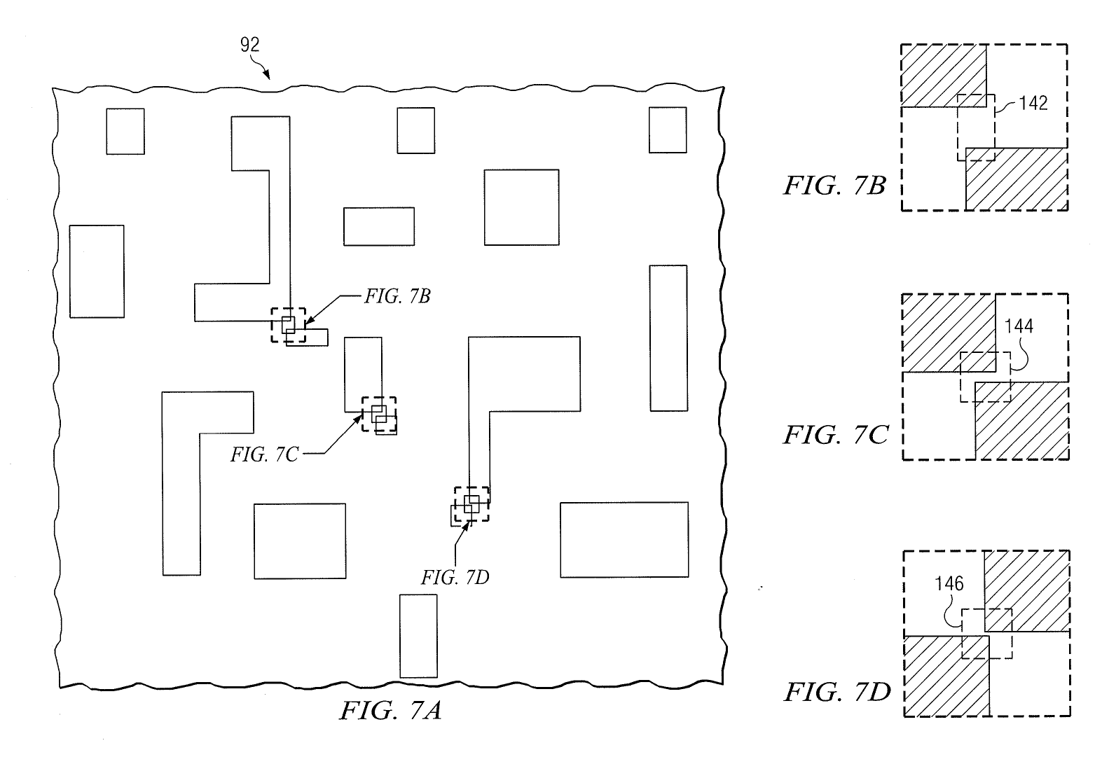

FIG. 5 illustrates a flow diagram for an example method 100 for inspecting a photomask, according to the teachings of the present disclosure. In one embodiment, method 100 includes identifying manufacturing rule violations in a photomask and automatically generating one or more DNIRs, each DNIR corresponding to a feature of mask pattern file 92 that violates the one or more manufacturing rules.

According to one embodiment, method 100 preferably begins at step 102. As noted above, teachings of the present disclosure may be implemented in a variety of configurations of system 90. As such, the preferred initialization point for method 100 and the order of the steps 102-112 comprising method 100 may depend on the implementation chosen.

At step 102, MRC module 94 (or another component of system 90) may perform one or more MRCs on mask pattern file 92. At step 104, MRC module (or another component of system 90) may identify one or more manufacturing rule violations. In certain embodiments, each manufacturing rule violation may correspond to a feature (e.g. features similar to features 72-86 of mask pattern file 70) of mask pattern file 92 that violates one or more of the manufacturing rules.

At step 106, DNIR module 96 (or another component of system 90) may analyze the manufacturing rule violations and automatically generate one or more DNIRs. In certain embodiments, each DNIR may correspond to a location of one or more of the identified manufacturing rule violations. In the same or alternative embodiments, DNIR module 96 may generate DNIRs in accordance with methods described below with reference to FIGS. 6-7H.

At step 108, the DNIRs generated at step 106 may be included as an input to an inspection job to be performed by automatic inspection module 98. At step 110, inspection module 98 may inspect regions of a photomask not within the one or more DNIRs using a first sensitivity, as discussed in greater detail above with respect to FIG. 4. At step 112, inspection module 98 may inspect the DNIRs generated at step 106 by DNIR module 98 using a second sensitivity, as discussed in greater detail above with respect to FIG. 4. After completion of step 112, method 100 may end.

Although FIG. 5 discloses a particular number of steps to be taken with respect to method 100, it is understood that method 100 may be executed with greater or lesser steps than those depicted in FIG. 5. For example, in certain embodiments of method 100, inspection system 98 may not perform an inspection of the one or more DNIRs using a second sensitivity, in which case method 100 may end after step 110. In addition, although FIG. 5 discloses a particular order of steps to be taken with respect to method 100, it is understood that steps 102-112 of method 100 may be executed in any order or manner consistent with the present disclosure. For example, in certain embodiments, step 112 of method 100 may be executed prior to step 110.

Method 100 may be implemented using system 90 or any other system operable to implement method 100. In certain embodiments, method 100 may be implemented in software embodied in tangible computer readable media.

FIG. 6 illustrates a flow diagram for an example method 120 for generating do-not-inspect regions (DNIRs), according to the teachings of the present disclosure. In one embodiment, method 120 automatically generates one or more DNIRs, each DNIR corresponding to a feature of mask pattern file 92 that violates one or more manufacturing rules. FIGS. 7A-7D illustrate a mask pattern file 92 containing manufacturing rule violations, in accordance with the teachings of the present disclosure. FIGS. 7E-7H illustrate the various steps of the method 120 depicted in FIG. 6, according to the teachings of the present disclosure. Generally, mask pattern file 92 may contain one or more manufacturing rule violations 142, 144 and 146 as depicted in FIGS. 7A-7D. Manufacturing rule violations 142, 144 and 146 may be identified by MRC module 94 depicted in FIG. 4, in accordance with step 104 of method 100 depicted in FIG. 5.

According to one embodiment, method 120 preferably begins at step 122. As noted above, teachings of the present disclosure may be implemented in a variety of configurations of system 90. As such, the preferred initialization point for method 120 and the order of the steps 122-134 comprising method 120 may depend on the implementation chosen.

At step 122, DNIR module 96 (or another component of system 90) may generate, for each manufacturing rule violation 142-146, a respective first region 148-152 comprising a polygon, as depicted in FIG. 7E. As shown in FIG. 7E, each respective first region 148-152 may have a length and/or width equal to a predetermined minimum spacing 154, and may be centered at approximately the location of its corresponding manufacturing rule violation. For example, DNIR module 96 may generate a first region 148 corresponding to manufacturing rule violation 142. First region 148 may have a length and/or width each equal to the predetermined minimum spacing 154, and may be centered at approximately the location of manufacturing rule violation 142. Similarly, DNIR module 96 may also generate a first region 150 centered at approximately the location of manufacturing rule violation 142 and a first region 152 centered at approximately the location of manufacturing rule violation 144, each of first regions 150 and 152 having a length and/or width equal to the predetermined minimum spacing.

Although each of first regions 148-152 are depicted in FIG. 7E as a square, it is understood that first regions 148-152 may comprise polygons other than a square, e.g. rectangle and/or more complex polygon.

The predetermined minimum spacing 154 may correspond to any parameter related to the generation of DNIRs and/or the inspection of photomasks. For example, in certain embodiments, the predetermined minimum spacing 154 may correspond to a minimum allowable spacing between DNIRs in a photomask inspection tool. In other embodiments, the predetermined minimum spacing 154 may correspond to a minimum allowable size of a DNIR in a photomask inspection tool.

At step 124, DNIR module 96 (or another component of system 90) may identify each first region 148-152 that overlaps with at least one other first region. For example, DNIR module 96 may determine that first region 150 overlaps with each of first regions 148 and 152.

At step 126, for each first region 148-152 identified to overlap with at least one other first region, DNIR module 96 may generate a respective second region 156 comprising the identified first region and the at least one other first region, as depicted in FIG. 7F. For example, as shown in FIG. 7F, first region 150, and each of first regions 148 and 152 that overlap with it, may be merged to generate a second region 156 comprising the overlapping first regions 148-152.

At step 128, DNIR module 96 may, for each second region 156, generate a respective third region 158, each third region 158 comprising a rectangle sized to be the smallest rectangle necessary to include the respective second region 156, as depicted in FIG. 7G. Stated another way, each third region 158 may comprise a rectangle sized such that its horizontal extent is equal to the horizontal extent of its corresponding second region 156, and its vertical extent is equal to the vertical extent of its corresponding second region 156.

At this point, each third region 158 may be sized to include all manufacturing rule violations 142-146 within the third region's respective second region 156 (and also the second region's corresponding first regions 148-152). However, each third region 158 may: (a) be larger than needed to include all manufacturing rule violations within the third region 158 and (b) may be within a predetermined minimum spacing 154 from another third region 158. Accordingly, at step 130, DNIR module 96 may reduce each of the length and the width of each third region 158 by the predetermined minimum spacing 154 (shown by elements 154a, 154b, 154c and 154d which each represent one-half the predetermined minimum spacing 154) to create a respective fourth region 160 comprising a rectangle concentric with its corresponding third region 156, as depicted in FIG. 7H.

At this point, each fourth region 160 may be sized to the minimum size necessary to include all manufacturing rule violations 142-146 within the fourth region's respective third region 158 (and also the third region's respective second region 156 and that second region's corresponding first regions 148-152). Accordingly, at step 132 DNIR module 96 (or another component of system 90) may generate a DNIR corresponding to each fourth region 160. In addition, for each first region that was not identified to overlap with another first region at step 124 above, DNIR module 96 may generate a DNIR corresponding to such first region. As a result, each DNIR may be sized to be small as possible in light of the predetermined minimum spacing, between DNIRs, while ensuring that each manufacturing rule violation is within a DNIR. After completion of step 132, method 120 may end.

The DNIRs generated pursuant to method 120 may be included in an inspection job setup (as shown in step 108 of method 100), and automatic inspection module 98 may inspect regions of a photomask not within the DNIRs using a first sensitivity and inspect the DNIRs using a second sensitivity (as shown in steps 110-112 of method 100).

Although FIG. 6 discloses a particular number of steps to be taken with respect to method 120, it is understood that method 120 may be executed with greater or lesser steps than those depicted in FIG. 6. In addition, although FIG. 6 discloses a particular order of steps to be taken with respect to method 120, it is understood that steps 122-132 of method 120 may be executed in any order or manner consistent with the present disclosure. For example, in certain embodiments, step 134 of method 120 may be executed prior to steps 126-134.

Method 120 may be implemented using system 90 or any other system operable to implement method 120. In certain embodiments, method 120 may be implemented in software embodied in tangible computer readable media.

In accordance with teachings of the present disclosure, disadvantages and problems associated with analyzing, generating DNIRs of a photomask have been substantially reduced or eliminated. For example, the methods and systems disclosed herein do not require access to circuit pattern in circuit design form, as required by conventional techniques, and allow for the automatic generation of DNIRs.

Although the present disclosure and its advantages have been described in detail, it should be understood that various changes, substitutions and alterations can be made herein without departing from the spirit and scope of the disclosure as defined by the following claims.

What is claimed is:

1. A method for inspecting a photomask, comprising:
performing one or more manufacturing rules checks (MRCs) on a mask pattern file;
identifying manufacturing rule violations; and
automatically generating one or more do-not-inspect regions (DNIRs), each DNIR corresponding to a location of one or more of the identified manufacturing rule violations.

2. A method according to claim 1, further comprising inspecting regions of the photomask outside of the one or more DNIRs using a first sensitivity.

3. A method according to claim 2, further comprising inspecting the one or more DNIRs using a second sensitivity.

4. A method according to claim 1, wherein automatically generating the one or more DNIRs comprises generating, for each manufacturing rule violation, a respective first region comprising a region with at least one of a length and a width equal to a predetermined minimum spacing and centered approximately at the location of the manufacturing rule violation.

5. A method according to claim 4, wherein automatically generating the one or more DNIRs further comprises generating a DNIR corresponding to each first region that does not overlap with another first region.

6. A method according to claim 4, wherein automatically generating the one or more DNIRs further comprises:
identifying each first region that overlaps with at least one other first region,
for each first region identified to overlap with at least one other first region, generating a respective second region comprising the identified first region and the at least one other first region;
for each second region, generating a respective third region, each third region comprising a rectangle sized to be the smallest rectangle necessary to include the respective second region;
reducing the length and width of each third region by a distance equal to the predetermined minimum spacing to create a respective fourth region comprising a rectangle concentric with its corresponding third region; and
generating a DNIR corresponding to each fourth region.

7. A method according to claim 4, wherein the predetermined minimum spacing corresponds to one of a minimum allowable spacing between DNIRs in a photomask inspection tool or a minimum allowable size of a DNIR in a photomask inspection tool.

8. A method according to claim 1, wherein at least one manufacturing rule violation indicates at least one of: (a) a feature too small to be resolved in a photomask manufacturing process, and (b) a region of the photomask that is uninspectable.

9. Software for inspecting a photomask, the software embodied in a tangible computer readable media and when executed operable to:
perform one or more manufacturing rules checks (MRCs) on a mask pattern file;
identify manufacturing rule violations; and
automatically generate one or more do-not-inspect regions (DNIRs), each DNIR corresponding to a location of one or more of the identified manufacturing rule violations.

10. Software according to claim 9, the software further operable to inspect regions of the photomask outside of the one or more DNIRs using a first sensitivity.

11. Software according to claim 9, the software further operable to inspect the one or more DNIRs using a second sensitivity.

12. Software according to claim 9, wherein automatically generating the one or more DNIRs comprises generating, for each manufacturing rule violation, a respective first region comprising a polygon with at least one of a length and a width equal to a predetermined minimum spacing and centered approximately at the location of the manufacturing rule violation.

13. Software according to claim 12, wherein automatically generating the one or more DNIRs further comprises generating a DNIR corresponding to each first region that does not overlap with another first region.

14. Software according to claim 12, wherein automatically generating the one or more DNIRs further comprises:
identifying each first region that overlaps with at least one other first region,
for each first region identified to overlap with at least one other first region, generating a respective second region comprising the identified first region and the at least one other first region;
for each second region, generating a respective third region, each third region comprising a rectangle sized to be the smallest rectangle necessary to include the respective second region;
reducing the length and width of each third region by a distance equal to the predetermined minimum spacing to create a respective fourth region comprising a rectangle concentric with its corresponding third region; and
generating a DNIR corresponding to each fourth region.

15. Software according to claim 12, wherein the predetermined minimum spacing corresponds to a minimum allowable spacing between DNIRs in a photomask inspection tool or a minimum allowable size of a DNIR in a photomask inspection tool.

16. Software according to claim 9, wherein at least one manufacturing rule violation indicates at least one of: (a) a feature too small to be resolved in a photomask manufacturing process, and (b) a region of the photomask that is uninspectable.

17. A system for inspecting a photomask, comprising:
a manufacturing rules check (MRC) module operable to:
perform one or more manufacturing rules checks (MRCs) on a mask pattern file; and
identify manufacturing rule violations; and
a do-not-inspect region (DNIR) module operable to automatically generate one or more DNIRs, each DNIR corresponding to a location of one or more of the identified manufacturing rule violations.

18. A system according to claim 17, further comprising an inspection module operable to inspect regions of the photomask outside the one or more DNIRs using a first sensitivity.

19. A system according to claim 17, the inspection module further operable to inspect the one or more DNIRs using a second sensitivity.

20. A system according to claim 17, the DNIR module further operable to generate, for each manufacturing rule violation, a respective first region comprising a polygon with at least one of a length and a width equal to a predetermined minimum spacing and centered approximately at the location of the manufacturing rule violation.

21. A system according to claim 20, the DNIR module further operable to generate a DNIR corresponding to each first region that does not overlap with another first region.

22. A system according to claim 20, the DNIR module further operable to:
identify each first region that overlaps with at least one other first region,
for each first region identified to overlap with at least one other first region, generate a respective second region comprising the identified first region and the at least one other first region;
for each second region, generate a respective third region, each third region comprising a rectangle sized to be the smallest rectangle necessary to include the respective second region;
reduce the length and width of each third region by a distance equal to the predetermined minimum spacing to create a respective fourth region comprising a rectangle concentric with its corresponding third region; and
generate a DNIR corresponding to each fourth region.

23. A system according to claim 20, wherein the predetermined minimum spacing corresponds to a minimum allowable spacing between DNIRs in a photomask inspection tool or a minimum allowable size of a DNIR in a photomask inspection tool.

24. A system according to claim 17, wherein at least one manufacturing rule violation indicates at least one of: (a) a feature too small to be resolved in a photomask manufacturing process, and (b) a region of the photomask that is uninspectable.
